(19) United States
(12) Patent Application Publication
(10) Pub. No.: US 2024/0035184 A1
(43) Pub. Date: Feb. 1, 2024

(54) Silver-Bismuth Electrolyte for Separating Hard Silver Layers

(71) Applicant: Umicore Galvanotechnik GmbH, Schwaebisch Gmuend (DE)

(72) Inventors: Sascha Berger, Schwaebisch Gmuend (DE); Klaus Bronder, Waeschenbeuren (DE); Claudia Blum, Schwaebisch-Gmund (DE); Bernd Weyhmueller, Alfdorf Hintersteinenberg (DE); Uwe Manz, Moegglingen (DE); Stephan Maier, Lorch (DE)

(21) Appl. No.: 18/256,321

(22) PCT Filed: Dec. 10, 2021
(86) PCT No.: PCT/EP2021/085127

§ 371 Date: Jun. 7, 2023

(30) Foreign Application Priority Data
Dec. 11, 2020 (DE) 10 2020 133 188.6

(51) Int. Cl. C25D 3/64; C22C 5/06; B32B 15/01

(52) U.S. Cl. CPC C25D 3/64; C22C 5/06; B32B 15/018

(57) ABSTRACT

The present invention relates to an electrolyte for deposition of hard silver layers, wherein the element bismuth is alloyed to the silver. The invention also relates to a method for deposition of a corresponding silver-bismuth alloy from an electrolyte according to the invention and to a correspondingly deposited layer.

The present invention relates to an electrolyte for deposition of hard silver layers, wherein the element bismuth is alloyed to the silver. The invention also relates to a method for deposition of a corresponding silver-bismuth alloy from an electrolyte according to the invention and to a correspondingly deposited layer.

Electrical contacts are used today in virtually all electrical appliances. Their applications range from simple plug connectors to safety-relevant, sophisticated switching contacts in the communications sector, for the automotive industry or for aerospace technology. Here the contact surfaces are required to have good electrical conductivity, low contact resistance with long-term stability, good corrosion and wear resistance with as low as possible insertion forces as well as good resistance to thermal stress. In electrical engineering, plug contacts are often coated with a hard-gold alloy layer, consisting of gold-cobalt, gold-nickel or gold-iron. These layers have good resistance to wear, good solderability, low contact resistance with long-term stability, and good corrosion resistance. Due to the rising price of gold, less expensive alternatives are being sought.

As a substitute for hard-gold plating, coating with silver-rich silver alloys (hard silver) has proven advantageous. Silver and silver alloys are amongst the most important contact materials in electrical engineering not only on account of their high electrical conductivity and good oxidation resistance. These silver-alloy layers have, depending on the metal that is added to the alloy, layer properties similar to those of currently used hard-gold layers and layer combinations, such as palladium-nickel with gold flash. In addition, the price for silver is relatively low compared with other precious metals, in particular hard-gold alloys.

For the deposition of hard silver layers, mainly silver-antimony electrolytes are used in industry. The deposited antimony-alloyed hard silver layers have a hardness of approximately 160-180 HV in the deposited state. The permanent hardness after temperature aging for up to 1000 h at 150° C. is approximately 120 HV. The requirements for temperature resistance are becoming increasingly strict. The electrical properties must also be taken into account. Pure silver is distinguished by very low values for contact resistance. The contact resistance of the silver alloy layers must not increase too much due to the alloying of the second metal and the resulting increase in hardness. The target value is a contact resistance of at most 10 mOhm at 50 cN contact force. Silver-antimony coatings with max. 3% antimony meet this requirement. However, as described, the permanent hardness is limited to values of max. 120-140 HV. Furthermore, the antimony(III) used in the electrolytes is anodically converted to its pentavalent oxidation state during operation and is therefore no longer effective as a hardening agent. This limits the service life of the electrolytes and makes processing more difficult, since a high level of analytical effort is required to determine the antimony(III) content.

The possibilities for use for contact surfaces in silver-antimony coatings are thus limited. In modern applications, thermal loads of up to 200° C. can often occur. What is important here is the permanent hardness, even at high temperatures, and low wear due to abrasion. Silver-bismuth electrolytes are described in the literature, but they do not allow sufficiently homogeneous and glossy coatings to be deposited over a wide current density range.

In US7628903B1, silver and silver alloys with Sn, Bi, In, Pb are electrolytically deposited from a non-cyanide electrolyte using aliphatic sulfides in the strongly acidic pH range. Problems arise here with the coating of copper or copper alloy layers, since they dissolve rapidly in the strongly acidic pH range.

JPH11279787A describes silver and silver alloy depositions with Sn, Bi, Zn, In, Cu, Sb, Ti, Fe, Ni or Co as alloying partners using aminothiophenol compounds, also in the strongly acidic pH range. Here too, there are problems with strongly acidic electrolytes when coating copper or copper alloy substrates.

The electrolytic deposition of silver-bismuth electrolytes by means of cyclic voltammetry is described in I. Valkova; I. Krastev, Transactions of the institute of metal finishing 80, (2002) 21-24. Here, a cyanide-free alkaline electrolyte which has only a low applicable current density and insufficient stability is used.

DE1182014B describes a method for galvanic deposition of a silver-antimony or silver-bismuth alloy having a high hardness. The cyanidic silver electrolyte uses a polyhydric amino alcohol to complex the alloying metals, but only allows current densities in the range up to 3 A/dm², which are not sufficient for coating in continuous systems

DE2731595B1 describes the use of a brightener combination of ketone-carbon disulfide condensation products in cyanide silver baths. However, alloying with bismuth is not mentioned in this case.

Based on these findings, the intention was thus to develop silver-bismuth alloy electrolytes with the aim of improving the properties of the electrolyte or the deposited layer within the context mentioned above. This and further objects which are not mentioned here but which are obvious to the person skilled in the art are solved by an electrolyte according to the present claim 1. Preferred configurations of the present electrolyte are described in the subclaims that are dependent on claim 1. Claims 4-9 relate to a method according to the invention for depositing the silver-bismuth alloys. Claims 10 and 11 are directed to the deposited layer and a layer sequence, respectively.

Galvanic baths are solutions containing metal salts from which electrochemically metallic precipitates (coatings) can be deposited on substrates (objects). Galvanic baths of this kind are often also referred to as ‘electrolytes’. Accordingly, aqueous galvanic baths are hereinafter referred to as ‘electrolytes’.

By providing an aqueous electrolyte for the electrolytic deposition of silver-bismuth alloys on conductive substrates, which electrolyte has the following features:
0.5-200 g/l based on the metal of a silver compound or a soluble anode comprising silver;
0.1-50 g/l based on the metal of a soluble bismuth compound;
5-200 g/l of a soluble cyanide, in particular potassium cyanide;
0.05-2 mol/l of a soluble di-, tri- or tetracarboxylic acid;
>0-5 g/l of a soluble brightener A which is a reaction product of ketones or dithiocarbamates with carbon disulfide;
>0-5 g/l of a further soluble brightener B selected from the group of condensation products of arylsulfonic acids with formaldehyde;
1-1000 mg/l of a soluble wetting agent; and
a pH value of 10-14, the solution to the stated problems is obtained. The silver-bismuth electrolyte described here has proved to be very stable. The bismuth(III) present is subject to significantly less oxidation compared to antimony(III). When silver-bismuth coatings are deposited, the advantages described above in terms of permanent hardness and electrical properties are obtained. Surprisingly, these coatings have very high and temperature-stable hardness values, reaching values of up to 250 HV in the initial state and still exceeding 200 HV even after 1000 hours of aging at 150° C. In contrast, only hardness values between 80 HV and 180 HV in the deposited state have been described in the literature for such layers. Where HV is referred to in the present text, this means Vickers hardness (DIN EN ISO 14577-1—latest version on the date of application).

The silver is provided in the electrolyte according to the invention via correspondingly soluble silver salts. These are preferably selected from silver methanesulfonate, silver carbonate, silver phosphate, silver pyrophosphate, silver nitrate, silver oxide, silver lactate, silver fluoride, silver bromide, silver chloride, silver iodide, silver thiocyanate, silver thiosulfate, silver hydantoins, silver sulfate, silver cyanide and alkali silver cyanide. Potassium silver cyanide is very preferred. The amount of silver can be selected by the skilled person specifically for their application purposes. In general, the silver concentration based on the metal is 0.5-200 g/l. In a preferred embodiment, this value is 1-100 g/l and especially preferably 10-50 g/l. Alternatively or additionally, the silver can also enter the electrolyte in the form of a soluble anode comprising silver (Praktische Galvanotechnik, 5th edition, Eugen G. Leuze Verlag, p. 342f, 1997).

The second alloy metal in the electrolyte according to the invention is bismuth. This can likewise be added to the electrolyte by means of compounds known to the person skilled in the art. The bismuth is preferably present in (III) oxidation state. Advantageous compounds in this context are those selected from bismuth(III) oxide, bismuth(III) hydroxide, bismuth(III) fluoride, bismuth(III) chloride, bismuth(III) bromide, bismuth(III) iodide, bismuth(III) methanesulfonate, bismuth(III) nitrate, bismuth(III) tartrate, bismuth(III) citrate, especially ammonium bismuth citrate. The amount of the metal can be selected by the person skilled in the art, but is generally 0.1-50 g/l based on the metal. In a preferred embodiment, this value is 0.5-10 g/l and especially preferably 1-5 g/l.

Free cyanides are also present in the electrolyte according to the invention. These are used in the form of soluble compounds. The person skilled in the art knows which compounds are suitable for the present purpose. Sodium cyanide or, in particular, potassium cyanide is preferably used in the present case. This also serves as a conducting salt. It is used in an amount of 5-200 g/l, preferably 10-100 g/l and very preferably 20-80 g/l.

The electrolyte contains certain organic compounds which have one or more carboxylic acid groups. In particular, these are di-, tri- or tetracarboxylic acids. These are well known to a person skilled in the art for the present purpose and can be found, for example, in the literature (Beyer-Walter, Lehrbuch der Organischen Chemie, 22nd Edition, S. Hirzel-Verlag, pp. 324 et seqq.). Particularly preferred in this context are acids selected from the group consisting of oxalic acid, citric acid, tartaric acid, succinic acid, maleic acid, glutaric acid, adipic acid, malonic acid, malic acid. Oxalic acid, malonic acid, citric acid and tartaric acid are highly preferred. The acids are naturally present in their anionic form in the electrolyte at the pH value to be set. The carboxylic acids mentioned here are added to the electrolyte at a concentration of 0.05-2 mol per liter, preferably 0.1-1 mol per liter and very particularly preferably between 0.2-0.5 mol per liter.

Reaction products of carbon disulfide and ketones or dithiocarbamates are used as brightener A in the electrolyte according to the invention. The person skilled in the art is aware of the products that can be used here. These are described, for example, in patents DE885036C, DE2731595B1 or DE959775C. Preferred ketones to be used in the present case are those selected from the group consisting of propanone, 2-butanone, 2-pentanone, 3-pentanone, 2,3-hexanedione, 2,4-hexanedione, 2,5-hexanedione, 3,4-hexanedione, 2-heptanone, 3-heptanone, 4-heptanone, 2,3-heptanedione, 2,4-heptanedione, 2,5-heptanedione, 2,4-heptanedione, 3,5-heptanedione, 2,6-heptanedione, acetophenone, Preferred dithiocarbamates to be used are those selected from the group consisting of alkali diethyl dithiocarbamate, alkali diphenyl dithiocarbamate.

These reaction products are used in an amount of >0-5000 mg/l, preferably 1-500 mg/l and especially preferably 5-200 mg/l in the electrolyte.

Brightener B, which is also used in the electrolyte, is a condensation product of one or more arylsulfonic acids and formaldehyde. Such polymerizates are known to the person skilled in the art. For example, in DE2731595B1, these are used together with the aforementioned condensation products of ketones and carbon disulfide in silver deposition. Particular preference is given to using 1-naphthalenesulfonic acid and 2-naphthalenesulfonic acid in this context. However, other arylsulfonic acids can also be used for this purpose and are within the reach of the person skilled in the art, for example phenolsulfonic acid, benzenesulfonic acid, 1,2-benzenedisulfonic acid, 1,3-benzenedisulfonic acid, 1,4-benzenedisulfonic acid, 1,5-naphthalenedisulfonic acid, pyridine-3-sulfonic acid. This brightener B is used in a concentration of >0-5000 mg/l, more preferably 5-2500 mg/l and very preferably 100-1000 mg/l in the electrolyte according to the invention.

In the present electrolyte, depending on the application, it is furthermore typically possible to use anionic and non-ionic surfactants as wetting agents, such as, for example, polyethylene glycol adducts, fatty alcohol sulfates, alkyl sulfates, alkyl sulfonates, aryl sulfonates, alkyl aryl sulfonates, heteroaryl sulfates, betains, fluorosurfactants, and salts and derivatives thereof (see also: Kanani, N: Galvanotechnik; Hanser Verlag, Munich Vienna, 2000; pp. 84 et seqq.). Wetting agents are also, for example, substituted glycine derivatives which are known commercially as Hamposyl®. Hamposyl® consists of N-acyl sarcosinates, i.e. condensation products of fatty acid acyl residues and N-methylglycine (sarcosine). Silver coatings that are deposited with these baths are white and glossy to highly glossy. The wetting agents lead to a pore-free layer. Further advantageous wetting agents are those selected from the following group:
non-ionic wetting agents such as, for example, beta-naphthol ethoxylate potassium salt, fatty alcohol polyglycol ethers, polyethylene imines, polyethylene glycols and mixtures thereof. Wetting agents with a molecular weight below 2,000 g/mol are particularly advantageous.
anionic wetting agents such as, for example, N-dodecanoyl-N-methylglycine, (N-lauroylsarcosine)-Na salt, alkyl collagen hydrolysate, 2-ethylhexyl sulfate-Na salt, lauryl ether sulfate-Na salt, 1-naphthalenesulfonic acid-Na salt, 1,5-naphthalenedisulfonic acid-Na salt and mixtures thereof,
cationic wetting agents such as, for example, 1H-imidazolium-1-ethenyl (or 3-methyl)-, methylsulfate homopolymers.

The electrolyte according to the invention is used within a basic pH range. Optimal results can be achieved with pH values of 10-14 in the electrolyte. The person skilled in the art will know how to adjust the pH value of the electrolyte. This is preferably in the strongly basic range, more preferably >11. It is highly advantageous to choose extremely strongly basic deposition conditions where the pH value is above 12 and can even reach 13 or even 14 in exceptional cases.

In principle, the pH value can be adjusted as required by the person skilled in the art. The person skilled in the art will be, however, guided by the idea of introducing as few additional substances into the electrolyte as possible that could adversely affect the deposition of the alloy in question. In an especially preferable embodiment, the pH value is therefore set solely by adding a base. The person skilled in the art can use all compounds suitable for a corresponding application as a base. Preferably, they will use alkali metal hydroxides for this purpose, in particular potassium hydroxide.

A further subject matter of the present invention is a method for the electrolytic deposition of silver alloy coatings from an electrolyte as just described. In the method, an electrically conductive substrate is immersed in the electrolyte according to the invention and a current flow is established between an anode in contact with the electrolyte and the substrate as cathode.

The temperature prevailing during the deposition of the silver and silver alloy coating can be selected as desired by the person skilled in the art. They will thereby be guided on the one hand by an adequate deposition rate and the applicable current density range, and on the other hand by economic aspects or the stability of the electrolyte. It is advantageous to set a temperature of 20° C. to 90° C., preferably 25° C. to 65° C., and especially preferably 30° C. to 50° C.

The current density that is established in the electrolyte between the cathode and the anode during the deposition process can be selected by the person skilled in the art on the basis of the efficiency and quality of deposition. Depending on the application and type of coating system, the current density in the electrolyte is advantageously set to 0.2 to 150 A/dm². If necessary, current densities can be increased or reduced by adjusting the system parameters, such as the design of the coating cell, flow rates, anode or cathode relationships, etc. A current density of 0.2-100 A/dm² is advantageous, 0.2-50 A/dm² is preferable, and 0.5-30 A/dm² is especially preferable.

In the context of the present invention, low, medium, and high current density ranges are defined as follows:
Low current density range: 0.1 to 0.75 A/dm²,
Medium current density range: greater than 0.75 A/dm² to 5 A/dm²,
High current density range: greater than 5 A/dm².

The electrolyte according to the invention and the method according to the invention can be used for the electrolytic deposition of silver-bismuth coatings for technical applications, for example electrical plug connectors and printed circuit boards, and for decorative applications such as jewelry and watches.

As has already been indicated above, the electrolyte according to the invention is an alkaline type. It may be that fluctuations with respect to the pH value of the electrolyte occur during electrolysis. In one preferred embodiment of the present method, the person skilled in the art will therefore proceed so that they monitor the pH value during electrolysis and adjust it to the setpoint value if necessary. Potassium hydroxide is advantageously used to set the pH value.

Various anodes can be employed when using the electrolyte. Soluble or insoluble anodes are just as suitable as the combination of soluble and insoluble anodes. If a soluble anode is used, it is particularly preferred if a silver anode or a silver bismuth anode or a bismuth anode is used (DE1228887, Praktische Galvanotechnik, 5th edition, Eugen G. Leuze Verlag, p. 342f, 1997).

Preferred as insoluble anodes are those made of a material selected from the group consisting of platinized titanium, graphite, mixed metal oxides, glass carbon anodes, and special carbon material (“diamond-like carbon,” DLC), or combinations of these anodes. Insoluble anodes of platinized titanium or titanium coated with mixed metal oxides are advantageous, wherein the mixed metal oxides are preferably selected from iridium oxide, ruthenium oxide, tantalum oxide and mixtures thereof. Iridium-transition metal mixed oxide anodes composed of iridium-ruthenium mixed oxide, iridium-ruthenium-titanium mixed oxide, or iridium-tantalum mixed oxide are also advantageously used for execution of the invention. More information may be found in Cobley, A.J et al. (The use of insoluble anodes in acid sulphate copper electrodeposition solutions, Trans IMF, 2001,79(3), pp. 113 and 114).

Typically, thin layer thicknesses in the range of 0.1 to 0.3 μm silver alloy are used, for example, for coating plastic caps in rack operation. Low current densities in the range from 0.25 to 0.75 A/dm² are used here. A further application of low current densities is used in drum or vibration technology, for example in the coating of contact pins. Here, approximately 0.5 to 3 μm silver alloy is applied in the current density range of 0.25 to 0.75 A/dm². Layer thicknesses in the range of 1 to 10 μm are typically deposited in rack operation for technical and decorative applications, with current densities in the range from 1 to 5 A/dm². For technical applications, a layer thickness of up to 25 μm is sometimes also deposited. In continuous systems, layer thicknesses over a relatively large range of approx. 0.5 to approx. 5 μm are deposited with the highest possible deposition rates, and thus the highest possible current densities of between 5 and 50 A/dm². In addition, there are also special applications in which relatively high layer thicknesses of a few 10 s of μm up to a few millimeters are deposited, for example in the event of electroforming.

Instead of direct current, pulsed direct current can also be applied. The current flow is thereby interrupted for a certain period of time (pulse plating). In reverse pulse plating, the polarity of the electrodes is switched, such that the coating is partially detached anodically. By constantly alternating said anodic detachment with cathodic pulses, the build-up of the layer is thus controlled. The application of simple pulse conditions, such as, for example, 1 s current flow (tₒₙ) and 0.5 s pulse pause (t_{off}) at average current densities yielded homogeneous, glossy, and white coatings.

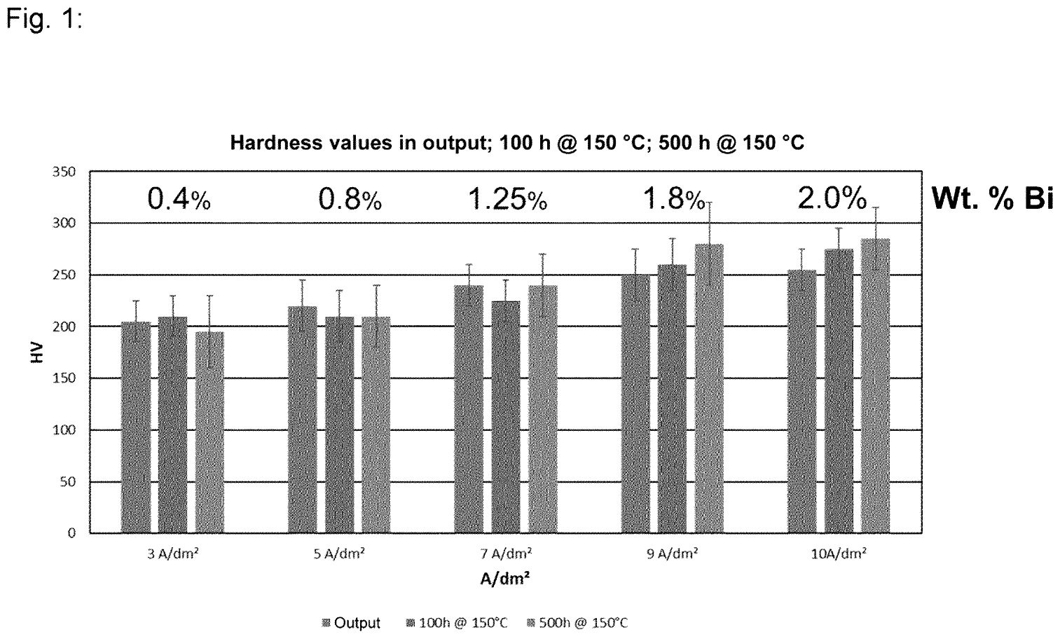

The present invention also relates to a silver-bismuth alloy layer having a thickness of 0.1-50 μm produced by the method according to the invention and having a hardness of >200 HV after annealing of the coating at 150° C. for 1000 h. An upper limit of the hardness lies in the technically available hardness of the metal layer. It can be 350 HV or more preferably even 400 HV (FIG. 1). The preferred thickness of the layer according to the invention lies in the ranges indicated above, preferably 0.5-30 μm and very preferably 1-5 μm.

Preferably, the alloy layer according to the invention is deposited on a nickel or nickel alloy layer or a copper or copper alloy layer. Suitable substrate materials which are advantageously used here are copper base materials such as pure copper, brass, bronze (e.g., CuSn, CuSnZn) or special copper alloys for plug connectors such as alloys with silicon, beryllium, tellurium, phosphorus, or iron-based materials such as iron or stainless steel or nickel or a nickel alloy such as NiP, NiW, NiB, gold or silver. The substrate materials may also be multilayer systems that have been galvanically coated or coated using other coating techniques. This includes, for example, ferrous materials which have been nickel-plated or copper-plated and then optionally gold-plated or coated with pre-silver. A further substrate material is a wax core which has been precoated with silver conductive lacquer (electroforming).

The present electrolyte delivers a shiny deposit giving a silvery impression. The deposited alloy metal layer advantageously has an L* value of over +97. The a* value is preferably −0.2 to 0.2 and the b* value between +2 and +4, according to the Cielab color system (EN ISO 11664-4—latest version as of the filing date). The values were determined with a Konica Minolta CM-700d.

The electrolyte according to the invention has long-term stability. By combining the brighteners described for the deposition of silver and the alloying of silver with bismuth, it was possible to obtain coatings suitable for the application described. These have sufficiently low contact resistances and, moreover, retain a surprisingly high hardness even after exposure to heat. This was not to be expected from the available state of the art.

### EXAMPLES

1 liter of the electrolyte specified in the respective exemplary embodiment are heated to the temperature specified in the exemplary embodiment by means of a magnetic stirrer, while being stirred with a cylindrical magnetic stirring rod 60 mm long at at least 200 rpm. This stirring and temperature is also maintained during the coating.

After the desired temperature has been reached, the pH value of the electrolyte is set using a KOH solution (c=0.5 g/ml) and a suitable acid such as sulfuric acid (c=25%) to the value specified in the exemplary embodiment.

Silver plates or mixed metal oxide-coated titanium are used as anodes.

A mechanically polished brass plate with a surface area of at least 0.2 dm² serves as cathode. This can be coated beforehand with at least 5 μm of nickel from an electrolyte which produces high-gloss layers. A gold layer approximately 0.1 μm thick may also be deposited on the nickel layer.

Prior to introduction into the electrolyte, these cathodes are cleaned with the aid of electrolytic degreasing (5-7 V) and an acid dip containing sulfuric acid (c=5% sulfuric acid). Between each cleaning step and before introduction into the electrolyte, the cathode is rinsed with deionized water.

The cathode is positioned in the electrolyte between the anodes and moved parallel thereto at at least 5 cm/second. The distance between anode and cathode should not change.

In the electrolyte, the cathode is coated by applying a direct electric current between anode and cathode. The current intensity is selected such that at least 0.5 A/dm² is achieved on the surface area. Higher current densities can be selected if the electrolyte specified in the application example is intended to produce layers that can be used for technical and decorative purposes.

The duration of the current flow is selected such that a layer thickness of at least 0.5 to 1 μm is achieved on average over the surface area. Higher layer thicknesses can be produced if the electrolyte specified in the application example is intended to produce layers of a quality that can be used for technical and decorative purposes.

After coating, the cathode is removed from the electrolyte and rinsed with deionized water. The drying of the cathodes can take place via compressed air, hot air, or centrifugation.

The surface area of the cathode, the level and duration of the applied current, and the weight of the cathode before and after coating are documented and used to determine the average layer thickness as well as the efficiency of deposition.

TABLE 1
Exemplary embodiments

| Example no. | 1 | 2 | 3 | 4 | 5 | 6 |
|---|---|---|---|---|---|---|
| Ag [g/l] | 22 | 22 | 40 | 30 | 50 | 22 |
| Bi [g/l] | 0.5 | 2 | 2.5 | 2.0 | 3 | 0.5 |
| Di-potassium | 0 | 0 | 60 | 30 | 0 | 5 |
| tartrate [g/l] | | | | | | |
| Tripotassium cit- | 100 | 60 | 0 | 0 | 0 | 150 |
| rate [g/l] | | | | | | |
| Di-potassium | 5 | 0 | 0 | 10 | 0 | 0 |
| oxalate [g/l] | | | | | | |
| Di-potassium | 0 | 10 | 0 | 0 | 50 | 0 |
| malonate [g/l] | | | | | | |
| Brightener A^{a)} | 7.5 | 0 | 50 | 0 | 40 | 0 |
| [mg/l] | | | | | | |
| Brightener A^{b)} | 0 | 25 | 0 | 40 | 0 | 0 |
| [mg/l] | | | | | | |
| Brightener A^{c)} | 250 | 0 | 0 | 0 | 0 | 10 |
| [mg/l] | | | | | | |
| Brightener B^{d)} | 1000 | 0 | 500 | 250 | 400 | 500 |
| [mg/l] | | | | | | |
| 2-ethylhexyl sulfate | 0 | 0 | 100 | 0 | 150 | 0 |
| [mg/l] | | | | | | |
| Lauryl methyl- | 0 | 0 | 0 | 50 | 0 | 0 |
| glycinate, Na salt | | | | | | |
| [mg/l] | | | | | | |
| Fatty alcohol poly- | 0 | 15 | 0 | 0 | 0 | 0 |
| glycol ether [mg/l] | | | | | | |
| Cocosamidopropyl- | 5 | 5 | 3 | 0 | 0 | 2 |
| dimethylammo- | | | | | | |
| nium2-hydroxypro- | | | | | | |
| pane sulfobetaine | | | | | | |
| [m/l] | | | | | | |
| pH | 13 | 12.8 | 13 | 13.2 | 13.5 | 12.5 |
| Temperature [° C.] | 30 | 35 | 40 | 40 | 50 | 30 |
| Anodes | Ag | Ag | Ag | Ag | MMO | Ag |
| Current density | 3 | 2 | 5 | 2 | 10 | 2 |
| [A/dm2] | | | | | | |
| Layer thickness | 1.8 | 2 | 3 | 2.5 | 1.5 | 2 |
| [μm] | | | | | | |
| Bi [wt. %] | 2.48 | 0.84 | 1.13 | 1.28 | 2.0 | 1.53 |
| Gloss | Yes/Haze | Yes/Haze | Yes | Yes/Haze | Yes/Haze | Yes |
| Color: L* | 96.05 | 98.2 | 98.11 | not | 97.76 | 97.7 |
| | | | | known | | |
| a* | −0.10 | −0.11 | −0.09 | not | −0.11 | −0.1 |
| | | | | known | | |
| b* | 4.3 | 2.09 | 2.25 | not | 2.35 | 2.49 |
| | | | | known | | |
| Hardness [HV] | 260 | 205 | 220 | not | 250 | 240 |
| | | | | known | | |

^{a)}reaction product of 2-butanone with carbon disulfide in accordance with DE2731595
^{b)}reaction product of 2,5-hexanedione with carbon disulfide in accordance with DE2731595
^{c)}reaction product of potassium phenyldithiocarbamate with carbon disulfide in accordance with DE959775
^{d)}naphthalenesulfonic acid-formaldehyde condensation product in accordance with DE2731595

Coatings obtained from an electrolyte according to Example No. 3 (Table 1) were aged at 150° C. for 100 and 500 hours and the hardness values were then determined. The results are shown in FIG. 1.

1. An aqueous electrolyte for electrolytic deposition of silver-bismuth alloys onto conductive substrates, the electrolyte having the following features:
0.5-200 g/l based on the metal of a silver compound or a soluble an-ode comprising silver;
0.1-50 g/l based on the metal of a soluble bismuth compound;
5-200 g/l of a soluble cyanide, in particular potassium cyanide;
0.05-2 mol/l of a soluble di-, tri- or tetracarboxylic acid;
>0-5 g/l of a soluble brightener A which is a reaction product of ke-tones or dithiocarbamates with carbon disulfide;
>0-5 g/l of a further soluble brightener B selected from the group of condensation products of arylsulfonic acids with formaldehyde;
1-1000 mg/l of a soluble wetting agent; and
a pH of 10-14.

2. The electrolyte according to claim 1, wherein the silver compound is selected from silver methanesulfonate, silver carbonate, silver phosphate, silver pyrophosphate, silver nitrate, silver oxide, silver lactate, silver fluoride, silver bromide, silver chloride, silver iodide, silver thiocyanate, silver thiosulfate, silver hydantoins, silver sulfate, silver cyanide and alkali silver cyanide.

3. The electrolyte according to claim 1, wherein the bismuth compound is selected from bismuth(III) oxide, bismuth(III) hydroxide, bismuth(III) fluoride, bismuth(III) chloride, bismuth(III) bromide, bismuth(III) iodide, bismuth(III) methanesulfonate, bismuth(III) nitrate, bis-muth(III) tartrate, bismuth(III) citrate, in particular ammonium bismuth citrate.

4. A method for electrolytic deposition of silver and silver alloy coatings from an electrolyte according to claim 1, wherein an electrically conductive substrate is immersed in the electrolyte and a current flow is established between an anode in contact with the electrolyte and the substrate as cathode.

5. The method according to claim 4, wherein the temperature of the electrolyte is 20° C. to 90° C.

6. The method according to claim 4, wherein the current density during electrolysis is 0.2 to 150 A/dm2.

7. The method according to claim 4, wherein the pH value during electrolysis is continuously set to a range between 10 and 14.

8. The method according to claim 4, wherein a silver-bismuth coating is deposited which has a thickness of 0.1-50 μm.

9. The method according to claim 4, wherein a soluble silver anode and/or an insoluble anode is used as the anode.

10. A silver-bismuth alloy layer having a thickness of 0.1-50 μm produced according to claim 4 and having a hardness of >200 HV after annealing of the coating at 150° C. for 1000 h.

11. The alloy layer according to claim 10, wherein said alloy layer is deposited on a nickel or a nickel alloy layer or a copper or copper alloy layer.
